(19) United States
(12) Patent Application Publication
(10) Pub. No.: US 2010/0218588 A1
(43) Pub. Date: Sep. 2, 2010

(54) System and Method for Calibrating an Absolute Position Sensor

(75) Inventors: Zbyslaw Staniewicz, Barrie (CA); Terry P. Cleland, Pickering (CA); Gary J. Spicer, Mississauga (CA)

Correspondence Address: MAGNA INTERNATIONAL, INC., 337 MAGNA DRIVE, AURORA, ON, L4G-7K1, CA

(73) Assignee: LITENS AUTOMOTIVE PARTNERSHIP, Woodbridge, ON (CA)

(21) Appl. No.: 12/161,392

(22) PCT Filed: Jan. 31, 2007
(86) PCT No.: PCT/CA2007/000119

§ 371 Date: Jul. 18, 2008

Related U.S. Application Data
(60) Provisional application No. 60/764,189, filed on Feb. 1, 2006.

(51) Int. Cl. G01D 18/00

(52) U.S. Cl. 73/1.75

(57) ABSTRACT

A system and method for calibrating an absolute angular position sensor and/or for providing pre-calibrated absolute angular position sensors comprises comparing, at a pre-elected number of angular positions, the angular position derived from the output of the sensor to the angular position reported by a reference sensor. The difference between the two outputs is used as an error correcting factor for the respective position. In addition to calibrating the sensor to reduce sensor errors, the calibration can also be used to determine the sensor output corresponding to an index position of interest.

### FIELD OF THE INVENTION

The present invention relates to a system and method for calibrating an absolute position sensor. More specifically, the present invention relates to a system and method for calibrating such a sensor, in situ, during assembly or repair of a mechanical device such as an internal combustion engine.

### BACKGROUND OF THE INVENTION

The assignee of the present invention has developed a novel sensor system and method which can be used to determine the absolute angular position of a rotating member with a high degree of accuracy. Implementations of the sensor system can be used, for example, to determine the angular position of a crankshaft or camshaft of an internal combustion engine to accuracies of better than one degree, even when the rotating member is rotating at speeds of greater than several thousand RPM.

While the sensor system and method can provide very high accuracies under a wide range of operating conditions and environments, the accuracy of the sensor system can suffer from errors in manufacturing and/or assembly tolerances unless it is calibrated prior to use. Ideally, the calibration of the sensor would be performed in situ, when it is installed on the system to be measured, and would be a simple and time efficient process to reduce the expense of the assembly process and/or to reduce the time required for assembly.

### SUMMARY OF THE INVENTION

It is an object of the present invention to provide a novel system and method for calibrating an absolute position sensor in situ which obviates or mitigates at least one disadvantage of the prior art.

According to a first aspect of the present invention, there is provided a method of calibrating an absolute position sensor, comprising the steps of: (i) for each of a selected set of angular positions, determining an angular position from the output of the sensor; (ii) for each of the selected set of angular positions, determining an angular position from a reference sensor; (iii) from the differences between each angular position from the output of the sensor and respective the angular position from the reference sensor, determining a set of error factors; and (iv) storing the determined error factors for use as correction factors to be applied to the determining angular positions from the output of the sensor to obtain calibrated angular positions.

According to another aspect of the present invention, there is provided a pre-calibrated angular position sensor comprising: a housing; a dipole carrier rotatably mounted within the housing, the dipole carrier including a dipole magnet at a first end and an engaging means at the opposite end, the engaging means being operable to engage a rotatable member to rotate the dipole carrier therewith; and a sensor mounted in the housing adjacent the dipole magnet such that the magnetic field of the dipole magnet rotates about the sensor as the rotating member rotates, wherein the sensor is calibrated after assembly by comparing the output of the sensor to the output of a reference sensor to derive a set of error values which can subsequently be applied to the output of the sensor to obtain a calibrated output.

### BRIEF DESCRIPTION OF THE DRAWINGS

Preferred embodiments of the present invention will now be described, by way of example only, with reference to the attached Figures, wherein:

FIGS. 1a through 1c show schematic representations of some of the possible sources of errors in an absolute position sensor and corresponding dipole magnet;

FIG. 2 shows a perspective view of the front of an internal combustion engine with a absolute angular position sensor installed on the crankshaft of the engine;

FIG. 3 shows a plot of the measured errors between the output of the sensor of FIG. 2 and a reference sensor;

FIG. 4 shows a plot of the output of the sensor of FIG. 2 after the error values of FIG. 3 have been applied as corrections;

FIG. 5 shows a perspective view of a pre-calibrated absolute position sensor installed on a camshaft of the engine of FIG. 2; and

FIG. 6 shows a cross section through the pre-calibrated sensor of FIG. 5.

### DETAILED DESCRIPTION OF THE INVENTION

Aspects of the sensor system and method developed by the assignee of the present invention are described in detail in co-pending PCT applications: “Rotational Position Sensor Based Engine Controller System”, publication no. WO 06/045186; “Engine Controller System and Method Employing High Speed Angular Position Sensor”, publication no. WO 06/045184; “Vehicle Control System And Method”, publication no. WO 06/045185; “System and Method For Measuring Torsional Vibrations In An Engine and Managing Operation of the Engine To Reduce Those Vibrations”, publication no. WO 06/045181; “Method and System for Starting Or Re-Starting An Internal Combustion Engine Via Selective Combustion”, publication no WO 06/045182; and “Rotational Position Sensor Based Engine Controller System”, publication no. WO 06/045186, the contents of each of which are incorporated herein by reference.

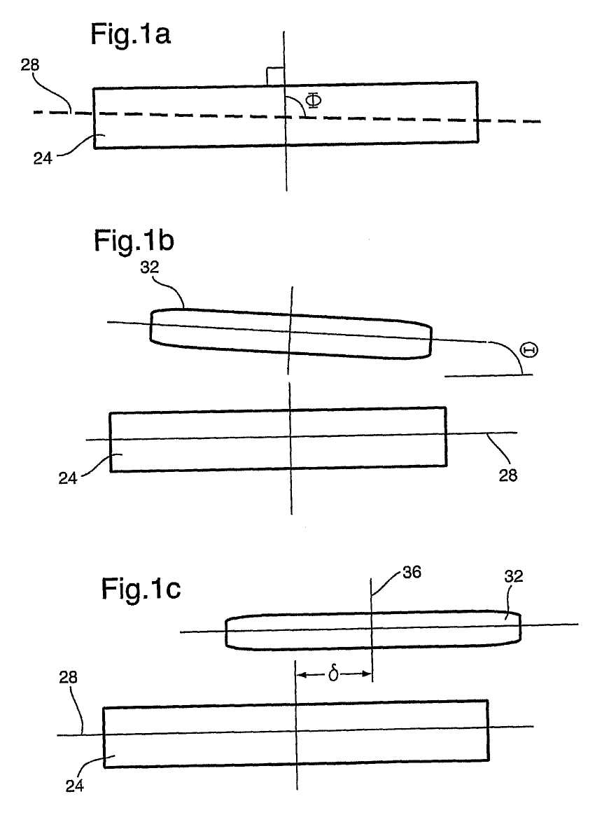

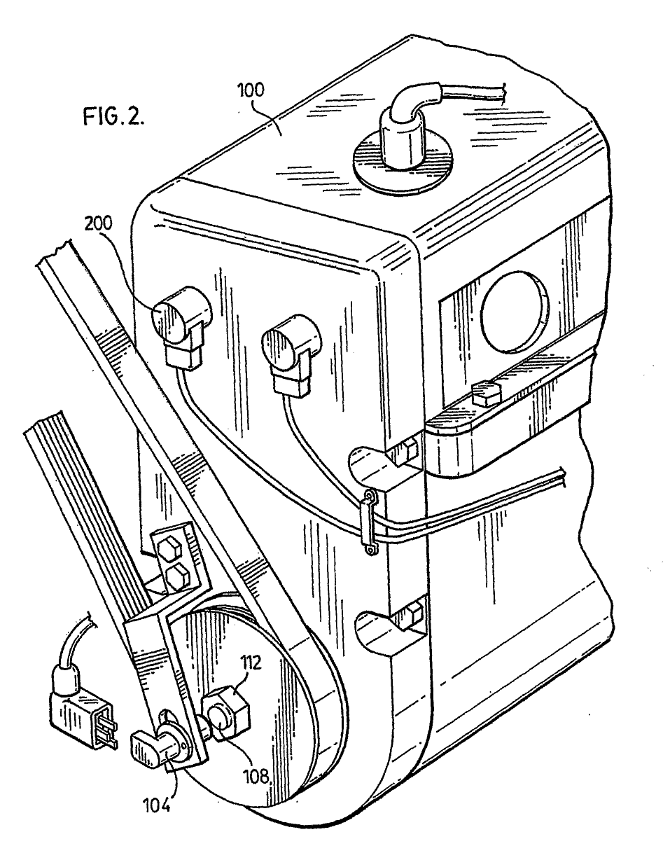

FIGS. 1a through 1c shows some examples of the types of manufacturing and/or installation errors which can affect the accuracy of the sensor system and method. In FIG. 1a, a sensor package 24, for use in the sensor system and method, is shown. Sensor package 24 can be a differential Hall Effect sensor package, such as the model 2SA-10 Sentron sensor manufactured by Sentron AG, Baarerstrasse 73, 6300 Zug, Switzerland or any other suitable sensor package.

Sensor package 24 has a sensor plane 28, defined by the positioning of the Hall Effect or other sensors in sensor package 24, which is the reference plane of the sensors of the package. Due to manufacturing tolerances, sensor plane 28 typically is oriented at some error angle Φ with respect to the mounting surfaces of sensor package 24 and this error angle Φ will result in measurement errors. While Φ is typically quite small, the induced errors are undesired and affect the accuracy of sensor package 24.

FIG. 1b shows another type of error which can affect the accuracy of sensor package 24. As illustrated, a dipole magnet 32 is positioned adjacent sensor package 24. As dipole magnet 32 is rotated, relative to sensor package 24, the magnetic field of dipole magnet 32 moves with respect to sensor package 24 and this movement is detected and measured by sensor package 24 to determine the angular position of a rotatable member to which dipole magnet 32 (or in some cases, sensor package 24) is affixed. However, as illustrated, during installation dipole magnet 32 can be mounted at some error angle θ with respect to sensor plane 28. Again, while error angle θ will typically be quite small, the induced errors are undesired and affect the accuracy of sensor package 24.

FIG. 1c shows yet another possible source of error for sensor package 24. As illustrated, in this example the center 36 about which dipole magnet 32 rotates is offset by an amount δ from the center of sensor plane 28. Again, δ is typically quite small, so that the induced errors are undesired and affect the accuracy of sensor package 24.

As will be apparent to those of skill in the art, in most installations, sensor package 24 will be subject to errors induced by some combination of Φ, θ and δ and/or other misalignment errors and manufacturing tolerances.

With careful manufacture and assembly of sensor 24 and dipole magnet 32, accuracy of better than about ±0.5 degrees can be obtained. Even higher accuracies, which can be desired for some applications, can be obtained with calibration of the sensor and dipole magnet. Accordingly, if it is desired to achieve higher accuracies with the sensor system and method, or if manufacturing and installation tolerances cannot be kept suitably small, it is necessary to calibrate the combination of sensor package 24 and dipole magnet 32 together.

FIG. 2 shows an internal combustion engine 100 which employs a sensor package 104 and a corresponding dipole magnet 108 to determine the angular position of a rotatable element, such as a crankshaft of engine 100. As illustrated, dipole magnet 108 is mounted to the head of a bolt 112 fastened to the end of the crankshaft of engine 100 and which rotates with the crankshaft. As will be apparent, while much of the following discussion relates to a sensor 24 and dipole magnet 32 for determining the angular position of a crankshaft, the same steps, techniques and considerations apply to sensors and dipole magnets for determining the angular position of a camshaft or any other rotating member.

The combination of sensor package 104 and dipole magnet 108 is potentially subject to a variety of misalignment and/or manufacturing tolerances and it is desired to calibrate the combination of sensor 104 and dipole magnet 108 to reduce errors which would otherwise be present in the angular position of the crankshaft reported by sensor package 104.

Accordingly, a calibration method in accordance with the present invention comprises the steps of rotating dipole magnet 108 through at least one complete revolution while recording the output of sensor package 104 and the output of another, reference, angular position indicator. The difference between the angular position output by sensor package 104 and the angular position from the other reference angular position indicator is determined for each of a series of angular positions and these differences are stored as a set of correction factors to be applied to the output of sensor package 104. In the preferred case wherein measurements are obtained over more than one revolution, the obtained measurements are averaged to reduce the effects of noise.

In the embodiment of FIG. 2, the crankshaft of engine 100 must be rotated through one complete revolution during the calibration process. Rotating the crankshaft of engine 100 can be achieved in a variety of manners, including the use of a pneumatic or electric drive motor externally connected to the crankshaft, use of the electric starter motor or alternator/starter of engine 100, manually turning the crankshaft with an appropriate wrench or tool (preferably with the sparkplugs removed from engine 100), etc.

As will be apparent to those of skill in the art, if the starter motor or starter alternator of engine 100 is used to rotate the crankshaft through its calibration revolution, the engine control unit (ECU) or other controller for engine 100 can be temporarily configured to inhibit firing of the ignition system of engine 100 and/or to prevent the injection of fuel into the combustion chambers of engine 100.

As mentioned above, while the crankshaft of engine 100 is being rotated through the complete revolution, the angular position derived from the output of sensor package 104 is compared to the angular position obtained from a reference angular position sensor. The type and/or operation of the reference angular position sensor is not particularly limited, provided the angular position can be determined with sufficient accuracy (better than the desired final accuracy of sensor 24) and can include incremental encoders such as the Haidenhain ER420 which is employed in a presently preferred embodiment of the invention.

If a separate drive, such as the above-mentioned pneumatic or electric drive motors, are employed to rotate the crankshaft of engine 100 through its calibration revolution, the reference angular position sensor can be integral with the separate drive. For example, a pneumatic or electric drive can have an integral optical encoder which provides the required angular position information.

As the output from sensor package 104 is an analog signal which is preferably converted to a set of sampled digital values, it is contemplated that the number of angular positions at which an angular position value will be determined and stored will be a power of two, i.e.—2ⁿ, such as five hundred and twelve or one thousand and twenty four and that the magnitude of the number of samples will be determined by the expected shape of the error curve. For an error curve which has a smooth, gradually changing curve, as few as 64 samples may be sufficient to calibrate the sensor whereas other rapidly changing error curves may require 512 or 1024 samples. It is contemplated that sensors will be calibrated with a sufficient number of samples for an expected worst case error curve which can be determined empirically or can be derived mathematically.

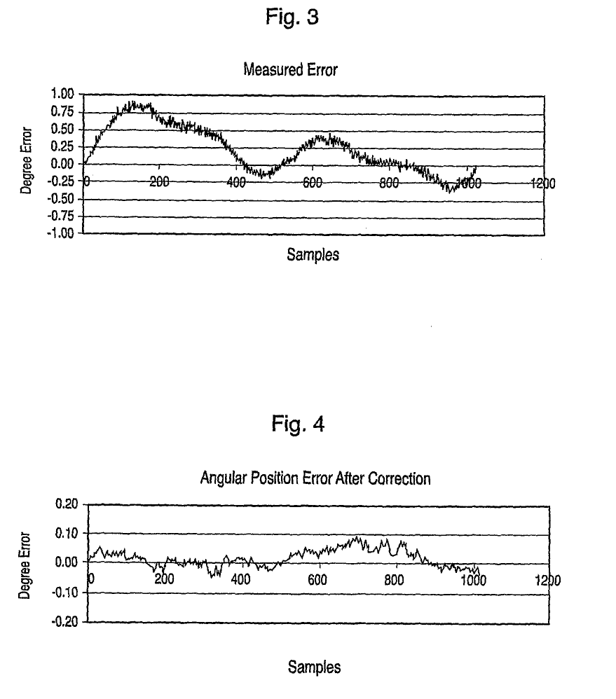

FIG. 3 shows a plot (the error curve) of the difference in the output from sensor package 104 and the reference angular position sensor, in this case an optical encoder system, over one thousand and twenty four samples per revolution of the crankshaft (i.e.—1024/360=2.844 samples per degree). As can be seen, the error in the output of sensor package 104 varies from about −0.3 degrees to about +0.9 degrees throughout the revolution of the crankshaft. To reduce the impact of unavoidable noise in the signal from sensor package 104, for the plot of FIG. 3 the measured error from sensor package 104 was obtained over three complete revolutions to obtain three sets of one thousand and twenty four samples, which were then averaged to obtain the values in the plot.

When sensor package 104 is used to determine the angular position of an engine crankshaft, the rotation of the crankshaft through one or more complete revolutions can also be used to determine the output of sensor package 104 when the crankshaft is at an index position of interest, such as top dead center (TDC) for piston number one. In such a case, the crankshaft is determined to be at the index position of interest by any suitable means, such as an index mark on the crankshaft or pulley attached to the crankshaft, or a pressure sensor connected to the number one cylinder, etc. and the output of sensor 104 at the index position of interest is then recorded and is associated with the index position of interest.

If sensor package 104 is used to determine the position of another rotatable member, such as a camshaft or vehicle suspension arm, etc. a similar procedure can be employed wherein the output of sensor package 104 is determined and stored when the rotatable member is at an index position of interest.

Returning now to the calibration process, once a set of error values is determined, they are stored in a two dimensional array, preferably non-volatile memory, for use by the system processing the signals from sensor package 104, which is typically a digital processor with an A/D converter, such as the ECU of engine 100.

In use, error correction of the position indicated by a signal from sensor package 104 merely comprises the steps of obtaining the analog signal from sensor package 104, converting it to a digital representation from which the angular position of the crankshaft, or other rotating member, can be determined, using the indicated angular position as the index to the array of stored error values, and subtracting the appropriate stored error value from the indicated angular position to obtain the error corrected angular position of the crankshaft.

If the determined angular position from sensor package 104 does not directly correspond to a position for which an error value has been determined, then the closest stored value can be used or an appropriate value can be interpolated. For example, if 1024 error values are stored for a complete revolution, an error value will be stored for sample 500, corresponding to 175.78 degrees, and for sample 501, corresponding to 176.65 degrees but no error value will be stored corresponding to 176.0 degrees. If the indicated angular position is 176 degrees, then the correction value for 175.78 degrees can be used or, if sufficient processing power is available and the increased accuracy is desired, an interpolation between the value stored for 175.78 degrees and the value stored for 176.65 degrees can be effected and used.

FIG. 4 shows a plot of the error, due mainly to sensor noise and/or mechanical play in the rotating member, in the output of the system used to create FIG. 3 when the determined error values are subtracted from the values from sensor package 104. As can be seen, the maximum error approaches, but does not reach, 0.1 degree and as this error is largely random, it is inherent and cannot be reduced by calibration.

While the embodiment discussed allows for in situ calibration of the sensor system and method, it is also contemplated that it can be preferred in many circumstances to have a pre-calibrated sensor system and method which can then be installed without requiring further calibration.

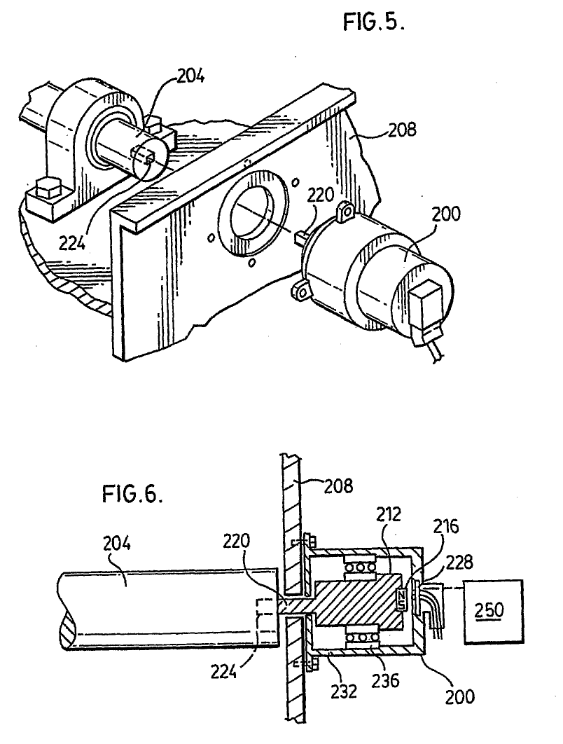

FIGS. 5 and 6 shows an example of a sensor package 200 which can be pre-calibrated and subsequently installed to measure the angular position of a rotating member 204. In the illustrated example, sensor package 200 is shown mounted on a timing cover 208 of an internal combustion engine and rotating member 204 is a camshaft.

Pre-calibrated sensor package 200 includes a dipole carrier 212, which is formed of a nonmagnetic material such as aluminum, zinc or plastic, to which a dipole magnet 216 is mounted. Alternatively, dipole carrier 212 can be formed of a magnetic material which is magnetized to integrally form dipole magnet 216.

Dipole carrier 212 includes a means for engaging the rotating member whose angular position is to be determined. In the illustrated embodiment, the means for engaging is a mating shaft 220 affixed to dipole carrier 212 and which extends from sensor package 200 to engage a feature 224 on rotating member 204. In the illustrated embodiment, feature 224 is a bore formed in the end of rotating member 204, the bore having an inner shape which is complementary to the outer shape of mating shaft 220, the complementary shape serving to fix the angular position of dipole carrier 212 relative to the angular position of rotating member 204.

It will be apparent to those of skill in the art that, in addition to fixing the angular position of mating shaft 220 relative to rotating member 204, the complementary shapes of feature 224 and mating shaft 220 can be selected to also index dipole carrier 212 to rotating member 204 (i.e.—mating shaft 220 can have the shape of an isosceles triangle, for example, to ensure that the angular position of dipole mating shaft 220 and the angular position of rotating member 204 are in a known relationship).

In this manner, if the engagement of mating shaft 220 to feature 224 is achieved with sufficient accuracy, pre-calibrated sensor package 200 can be installed to measure the angular position of a rotating member such as a crankshaft or camshaft without requiring a separate step of determining an index position of interest, such as TDC for piston number one, as the indexed engagement of mating shaft 220 and feature 224 results in the index position of interest being known. If the tolerances on the engagement of mating shaft 220 to feature 224 are too large, then the calibration of the index position of interest can be performed as described previously above.

As will be apparent to those of skill in the art, the present invention is not limited to dipole carrier 212 having a mating shaft 220 and rotating member 204 having a feature 224 and feature 224 can be formed on dipole carrier 212 and mating shaft 224 formed on rotating member 204, or any other method of joining dipole carrier 212 and rotating member 204 can be employed as desired. For example, each of rotating member 204 and dipole carrier 212 can include a feature 224 and an intermediate member (not shown) can engage each feature 224 to fix dipole carrier 212 to rotate with rotating member 204.

As shown in FIGS. 5 and 6, a suitable sensor 228 such as the model 2SA-10 Sentron sensor discussed above, is affixed to the housing 232 of sensor package 200 adjacent dipole magnet 216. As is also shown, dipole carrier 212 is mounted within housing 232 via a bearing, which in the illustrated embodiment is a roller bearing 236 although any other suitable type of bearing, as would occur to those of skill in the art, can be used.

As will now be apparent, when dipole carrier 212 is rotated with rotating member 204, by the means for engaging, the magnetic field from dipole magnet 216 rotates with respect to sensor 228 thus resulting in sensor 228 outputting a signal representative of the angular position of rotating member 204.

As will now also be apparent, as the positions and configurations of dipole magnet 216 and sensor 228 are established when sensor package 200 is assembled, sensor package 200 can be calibrated prior to sensor package 200 being installed on an engine or other device wherein an angular position is to be determined. Specifically, after assembly, sensor package 200 can be placed in a calibration jig (not shown) wherein dipole carrier 212 is rotated through at least one, and preferably several, complete revolutions while a reference encoder, such as an optical encoder or a previously calibrated sensor system in accordance with the present invention, measures the actual angular position of dipole carrier 212 and compares that actual angular position to the angular position output from sensor 228 to derive the above described set of error values.

Once these values are determined for an assembled sensor package 200, they can be provided in any suitable manner, such as on an EPROM, Flash memory, disc drive, text listing, etc. to the end user along with the sensor package 200. The end user can then install the sensor package 200 and provide the array of error values to the processing system which will process the signals from sensor 228 to determine the angular position of rotating member 204.

It is also contemplated that assembled sensor package 200 can include a suitable A/D converter and processor 250 which can operate on the analog signal from sensor 228 to output a digital signal representing the angular position measured by sensor 228. In such a case, the error values can be stored in sensor package 200 and used by the processor to directly output a calibrated signal.

As should now also be apparent to those of skill in the art, a pre-calibrated sensor package such as sensor package 200 can be used as the reference angular position sensor when installing a non calibrated sensor package, such as the above-described sensor package 24.

The present invention provides a simple and efficient system and method for calibrating an absolute angular position sensor and/or for providing pre-calibrated absolute angular position sensors. In addition to calibrating the sensor to reduce sensor errors, the calibration can also be used to determine the sensor output corresponding to an index position of interest.

The use of absolute position sensor mounted on at least one of the camshafts with an incremental sensor on the crankshaft allows achieving all the functionality of the existing incremental sensors (VVT position monitoring, determining crankshaft half-cycle within 0° to 720° range), with improved accuracy. By having capabilities to acquire precise timing error data, additional functions can be executed in the engine management scheme, like belt/chain elongation monitoring, active vibration control, tensioner failure detection,

To simplify the calibration process of a second absolute position sensor mounted relative to a camshaft, the camshaft sensor is calibrated against the first absolute position sensor mounted on the crankshaft. Although these sensors are attached to and are monitoring positions of 2 different shafts, relationship between shafts is known and predictable due to synchronicity of the timing system. In this manner, the position sensor mounted relative to the crankshaft becomes the reference sensor.

The calibration process would be executed by the ECU, and driven by pulses coming from the crankshaft sensor. Each pulse (n) intercepted by the ECU would initiate an interrupt service routine doing the following:

1. Update crankshaft position

CrankPos(n)=CrankPos(n−1)+Delta,

Where Delta is an angle increment per pulse, eg. at 60 teeth 360/60=6°

2. Acquire camshaft sensor signals, and calculate camshaft position

CamPos(n)=fₙ[sin,cos]

3. Calculate error at n position

Error(n)=CrankPos(n)−CamPos(n)

4. Store error value for future use as correction table

After calibration is complete, camshaft position is calculated for each time utilizing the corresponding nearest element from the correction table, which is selected and added to the result, improving accuracy of the position signal.

This method, although simple and applicable in both assembly and service environment, has limited accuracy. It is due to flexibility of the link between shafts (belt or chain), which introduces timing error. In order to minimize this error, it is recommended to run calibration process at low rpm, without combustion. This can be realized by driving engine with external electric drive or, in case of service shop, by using starter motor. In this scenario dynamic component of timing error is negligible. Static component, which is a result of valves friction, can be calculated and verified by testing. Distribution of this error is predictable and consistent, as to the level, shape and location within shaft revolution. Typically static component of timing error is below 0.2°.

Depending on application requirements, timing error may be ignored and will affect final result of camshaft position calculation. But if increased accuracy is needed, additional correction may be applied to the correction table, based on calculated distribution of timing error.

The above-described embodiments of the invention are intended to be examples of the present invention and alterations and modifications may be effected thereto, by those of skill in the art, without departing from the scope of the invention which is defined solely by the claims appended hereto.

We claim:

1. A method of calibrating an absolute position sensor mounted for determining an absolute position of a rotatable element, comprising the steps of:
(i) rotating a rotatable element relative to said absolute position sensor through a full revolution,
(ii) determining an angular position from the output of the sensor for each of a selected set of angular positions;
(ii) determining an angular position from a reference sensor for each of the selected set of angular positions;
(iii) calculating a difference between each angular position from the output of the sensor and respective the angular position from the reference sensor; and
(iv) storing each difference as a set of error factors for use as correction factors to be applied to the output of the sensor to obtain calibrated angular positions of said rotatable element.

2. A method of calibrating an absolute position sensor as set forth in claim 1, further comprising a step of converting said set of error factors to a set of digital values.

3. A method of calibrating an absolute position sensor as set forth in claim 2, wherein said set of error factors has a number of digital values and said number is 2ⁿ.

4. A method of calibrating an absolute position sensor as set forth in claim 3, wherein n is at least 6.

5. A method of calibrating an absolute position sensor as set forth in claim 4, further comprising storing said set of error factors in a two dimensional array.

6. A method of calibrating an absolute position sensor as set forth in claim 5, wherein the method includes repeating said steps for at least three revolutions of said rotatable element.

7. A method of calibrating an absolute position sensor as set forth in claim 6, wherein the method includes averaging said set of error factors for each angular position.

8. A method of calibrating an absolute position sensor as set forth in claim 7, wherein said method further comprises a step of recording the output of said sensor when said rotatable element is at an index position and associating the output with the index position.

9. A method of calibrating an absolute position sensor as set forth in claim 8, wherein said method further comprises calibrating a second absolute position sensor relative to said sensor, said second absolute position sensor mounted for determining an absolute position of a second rotatable element, said second rotatable element in synchronized rotation with said first rotatable element.

10. A method of calibrating an absolute position sensor as set forth in claim 9, wherein said step of calibrating a second absolute position sensor relative to said sensor comprises:
determining an angular position of said first rotating element;
acquiring sensor signals from said second absolute position sensor;
calculating angular position of said second rotatable element;
calculating an error value at said angular position of said second rotatable element relative to said first rotating element; and
storing said error value with said angular position in a second two dimensional array for use as second correction factors to be applied to the output of the second sensor to obtain calibrated angular positions of said second rotatable element.

11. A method of calibrating an absolute position sensor mounted for determining an absolute position of a rotatable element, comprising the steps of:
(i) rotating a first rotatable element relative to said absolute position sensor through a full revolution,
(ii) determining an angular position from the output of the sensor for each of a selected set of angular positions;
(ii) determining an angular position of a reference rotatable element from a reference sensor for each of the selected set of angular positions, said reference rotatable element being synchronized with said first rotatable element;
(iii) calculating a difference between each angular position from the output of the sensor and respective the angular position from the reference sensor; and
(iv) storing each difference as a set of error factors for use as correction factors to be applied to the output of the sensor to obtain calibrated angular positions of said rotatable element.

12. A method as set forth in claim 11, wherein said first rotatable element is a camshaft and said reference rotatable element is a crankshaft.

13. A pre-calibrated angular position sensor comprising
a housing;
a dipole carrier rotatably mounted within the housing, the dipole carrier including a dipole magnet at a first end and an engaging means at the opposite end, the engaging means being operable to engage a rotatable member to rotate the dipole carrier therewith; and
a sensor mounted in the housing adjacent the dipole magnet such that the magnetic field of the dipole magnet rotates about the sensor as the rotating member rotates, wherein the sensor is calibrated after assembly by comparing the output of the sensor to the output of a reference sensor to derive a set of error values which can subsequently be applied to the output of the sensor to obtain a calibrated absolute position signal.

14. A pre-calibrated angular position sensor as set forth in claim 13, further comprising a processor for storing said error values.

15. A pre-calibrated angular position sensor as set forth in claim 14, wherein said processor applies said error values to said output of said sensor to output said calibrated absolute position signal.
